(19) United States
(12) Patent Application Publication
(10) Pub. No.: US 2025/0378340 A1
(43) Pub. Date: Dec. 11, 2025

(54) Generating Architecture Solutions

(71) Applicant: International Business Machines Corporation, Armonk, NY (US)

(72) Inventors: Ahamed Jalaldeen Shahul Hamid, Bangalore (IN); Mukundan Sundararajan, Bangalore (IN)

(21) Appl. No.: 18/738,389

(22) Filed: Jun. 10, 2024

(51) Int. Cl. G06N 3/0895

(52) U.S. Cl. CPC G06N 3/0895

(57) ABSTRACT

Generating architecture solutions is provided. An Extensible Markup Language Metadata Interchange (XMI) representation of a Unified Modeling Language (UML) model corresponding to an architecture solution is generated based on a set of instructions in a predefined format. The UML model corresponding to the architecture solution is generated based on the XMI representation of the UML model.

### BACKGROUND

The disclosure relates generally to architectures and more specifically to generating architecture solutions.

An architecture describes the components that together form a solution. An architecture describes what the components do and how the components interact with each other. An architect designs or develops an architecture for a particular project.

A reference architecture is a generic architecture, which contains typical components, but is not specific to any particular project. As such, a reference architecture encapsulates established concepts. In other words, a reference architecture describes the best practices for a certain type of architecture solution. An architect can use a reference architecture as a basis for a project-specific architecture and adjust the reference architecture to the specific needs of that particular project.

A modeling language is any artificial language that can be used to express data, information, or systems in an architecture that is defined by a consistent set of rules. The rules are used for interpretation of the meaning of components in the architecture. A modeling language can be graphical or textual. Graphical modeling languages use a diagram technique with named symbols that represent concepts and lines that connect the symbols and represent relationships and various other graphical notation to represent constraints. Textual modeling languages may use standardized keywords accompanied by parameters or natural language terms and phrases to make computer-interpretable expressions. It should be noted that some modeling languages are executable.

Unified modeling language (UML) is a general-purpose visual modeling language that is intended to provide a standardized way to visualize the design of an architecture. In other words, UML offers a way to visualize an architecture’s blueprint in a diagram, including elements, such as, for example, activities, components, how the components interact with one another, how the architecture works, and the like.

XML Metadata Interchange (XMI) is a standard for exchanging metadata information via Extensible Markup Language (XML). XMI can be used as an interchange format for UML models as well as for other modeling languages. For example, XMI can be used for any metadata with a metamodel expressed in Meta-Object Facility, which is a platform-independent model.

### SUMMARY

According to one illustrative embodiment, a computer-implemented method for generating architecture solutions is provided. A computer generates an Extensible Markup Language Metadata Interchange (XMI) representation of a Unified Modeling Language (UML) model corresponding to an architecture solution based on a set of instructions in a predefined format. The computer generates the UML model corresponding to the architecture solution based on the XMI representation of the UML model. According to other illustrative embodiments, a computer system and computer program product for generating architecture solutions are provided.

### BRIEF DESCRIPTION OF THE DRAWINGS

FIG. 1 is a pictorial representation of a computing environment in which illustrative embodiments may be implemented;

FIG. 2 is a diagram illustrating an example of an architecture solution generation system in accordance with an illustrative embodiment; and

FIGS. 3A-3C are a flowchart illustrating a process for generating architecture solutions in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

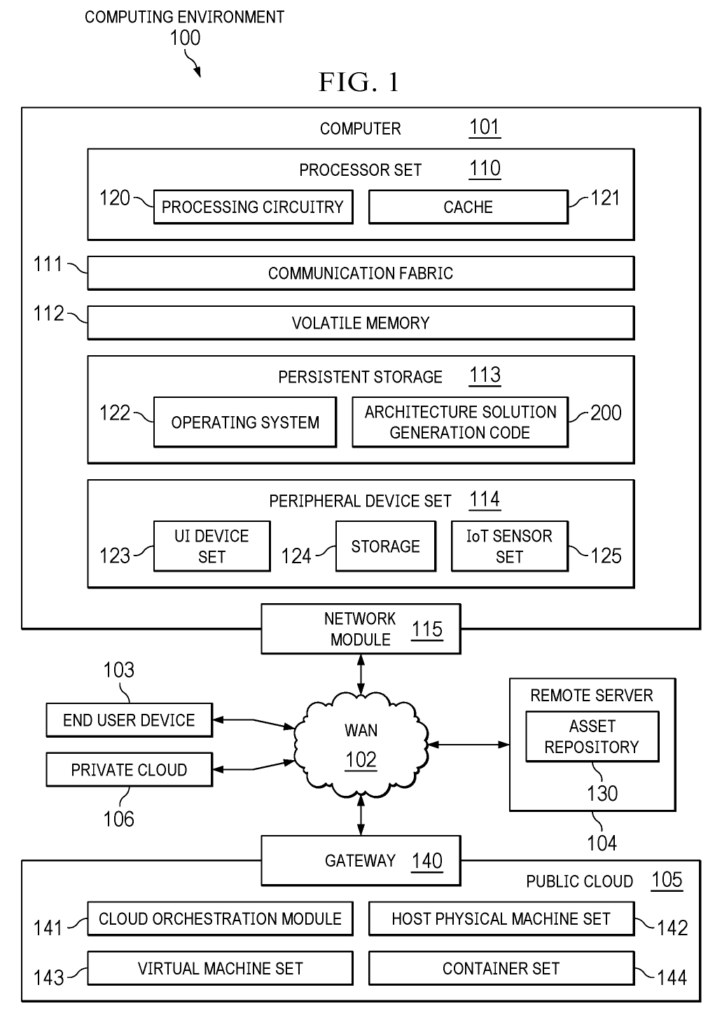

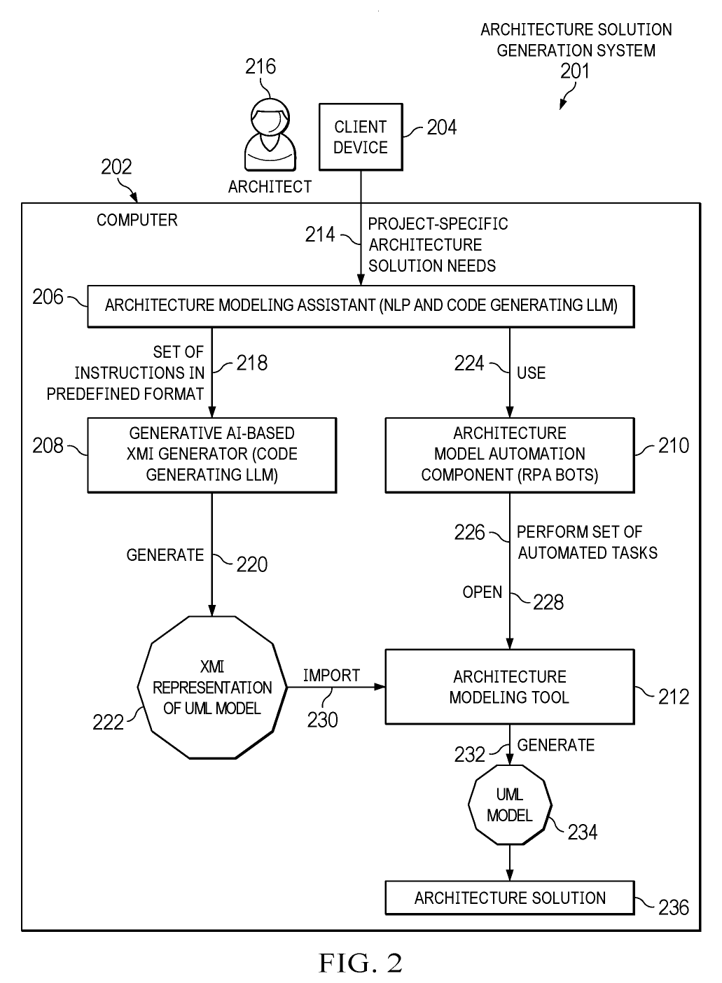

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as architecture solution generation code 200. For example, architecture solution generation code 200 accelerates the generation of architecture solutions utilizing robotic process automation and increases accuracy of generated architecture solutions utilizing self-learning generative artificial intelligence (AI).

In addition to architecture solution generation code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and architecture solution generation code 200, as identified above), peripheral device set 114 (including user interface (UI) device set 123, storage 124, and Internet of Things (IoT) sensor set 125), and network module 115. Remote server 104 includes asset repository 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a repository, such as asset repository 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in architecture solution generation code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., an architect who utilizes the architecture solution generation services provided by computer 101), and may take any of the forms discussed above in connection with computer 101. EUD 103 typically receives helpful and useful data from the operations of computer 101. For example, in a hypothetical case where computer 101 is designed to provide an architecture solution to the end user, this architecture solution would typically be communicated from network module 115 of computer 101 through WAN 102 to EUD 103. In this way, EUD 103 can display, or otherwise present, the architecture solution to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide an architecture solution based on reference architecture solution data, then this reference architecture solution data may be provided to computer 101 from asset repository 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Users, such as, for example, architects, utilize architecture modeling tools to generate architecture solutions, visualize the architecture solutions, conduct architecture solution viability assessments, perform architecture solution reviews, and generate architecture solution work products from architecture models. However, despite use of standard architecture methods across architecture solution projects, generating architecture models in each new architecture solution project increases manual effort, duration, and costs, which pose the risk of going over allotted time and budget. Architecture modeling tools, such as, for example, IBM® Cognitive Architect, IBM IT Architect Assistant, and the like, provide a semantic search facility to find existing reference architecture models and architecture models corresponding to previous architecture solution projects in an architecture model repository. These existing architecture models can be duplicated in part or in full and modified manually to match user-specified needs for a new architecture solution project. Typically, creating a new architecture model from the beginning takes comparatively less effort and duration, and has less complexity than modifying existing architecture models.

It should be noted that an architecture diagram, which is a smallest component of an architecture solution, provides a visual representation of an architecture from an architecture context, such as, for example, components, class, infrastructure, deployment, and the like. The architecture diagram contains model elements, such as, for example, actors, components, classes, interfaces, use cases, and the like, which are suitable for the specific architecture context and the relationships between model elements (e.g., an actor “uses” a use case). An architecture work product is a document that contains a set of architecture diagrams and text descriptions of the set of architecture diagrams. Architects utilize architecture work products as a means of communicating with software application development teams. Furthermore, architecture work products can be included in client deliverables. Multiple architecture work products can be generated manually or automatically from a single architecture model. An architecture model is a container that includes a set of one or more architecture diagrams, model elements, and model element relationships. An architecture solution can include a set of one of more architecture models. An architecture solution is a blueprint of a solution to be developed for a client or an entity. Thus, an architecture solution has a one-to-many relationship with architecture models. An architecture model has a one-to-many relationship with architecture diagrams. In addition, an architecture model has a one-to-many relationship with architecture work products.

Currently, generative AI-based tools, which are used to generate architecture diagrams with Unified Modeling Language (UML) notations, create discrete architecture diagrams and store those architecture diagrams in an image format, such as, for example, Joint Photographic Experts Group (JPEG) format or the like. However, architecture diagrams generated in an image format have several limitations. For example, a UML diagram generated in an image format does not contain model elements (e.g., components, classes, use cases, and the like), which are used to construct architecture diagrams, or model element metadata such as model element attributes, model element behaviors, and model element relationships (e.g., generalization, association, or the like) between model elements. Also, a UML diagram generated in an image format does not use a UML model as a container to hold a plurality of UML diagrams corresponding to an architecture solution, the model elements used in the plurality of UML diagrams, and the relationships established between the model elements used in the plurality of UML diagrams.

Absence of model elements and model element metadata prevents the use of automation processes, such as, for example, validating UML models, assessing architecture viability, generating work products, generating test cases, and generating code from UML diagrams in an image format. In addition, current architecture modeling tools cannot open, modify, or enhance UML diagrams in an image format. Further, a new image of an updated UML diagram needs to be generated each time to incorporate any changes or enhancements to a UML diagram, thus lacking traceability. Due to the limitations associated with architecture diagrams generated in an image format above, a need exists to accelerate architecture modeling in architecture modeling tools.

Illustrative embodiments utilize an architecture modeling assistant, which is a generative AI-based digital assistant, to receive project-specific architecture solution needs for architecture solutions from users via text and/or voice inputs to generate UML models with model elements and model element relationships that are compatible with the architecture modeling tool of illustrative embodiments. Illustrative embodiments select a foundation model for the architecture modeling assistant that utilizes natural language processing to process project-specific architecture solution needs received in a text format and/or a voice format and generate a set of equivalent instructions (e.g., prompts) in a predefined format, which is utilized by a generative AI-based XMI generator and an architecture model automation component of illustrative embodiments.

Illustrative embodiments also select a foundation model for the generative AI-based XMI generator, which generates an XML Metadata Interchange (XMI) representation of a UML model, along with model elements and relationships between the model elements, based on the generated set of equivalent instructions in the predefined format. Illustrative embodiments generate a Large Language Model (LLM) for the generative AI-based XMI generator by fine-tuning the foundation model with XMI support in generative AI studio software using sample instructions and corresponding sample XMI representations of existing UML models. In addition, it should be noted that the generative AI-based XMI generator can also modify XMI representations of existing UML Models, which were created either manually or via automation. Also, it should be noted that even though illustrative embodiments utilize an XMI representation of UML models herein, alternative illustrative embodiments can utilize any equivalent format, such as, for example, mxGraph XML, to represent UML models, which include diagrams, model elements, and relationships between model elements.

Illustrative embodiments utilize the architecture model automation component to automatically perform various tasks. For example, illustrative embodiments utilize the architecture model automation component to automatically import a generated XMI representation of a UML model to the architecture modeling tool of illustrative embodiments from the generative AI-based XMI generator. In addition, illustrative embodiments utilize the architecture model automation component to verify compatibility of the generated XMI representation of the UML model with the architecture modeling tool. Further, illustrative embodiments utilize the architecture model automation component to validate the generated UML Model based on standard UML model validation rules and architecture solution-specific UML model validation rules. Furthermore, illustrative embodiments utilize the architecture model automation component to rank the generated UML model against principles and standards defined for the architecture solution. Moreover, illustrative embodiments utilize the architecture model automation component to generate an XMI representation compatibility report, a UML model validation report, and a UML model rank report for the user. Also, illustrative embodiments utilize the architecture model automation component to automatically align the model elements in the UML diagrams in the generated UML model for the architecture modeling tool. It should be noted that illustrative embodiments can integrate the generative AI-based XMI generator and the architecture model automation component with the architecture modeling assistant. Illustrative embodiments can implement this invention in the architecture modeling tool as a web-based interface that can be accessed by a web browser and as a standalone component that is installed locally on a machine.

Thus, unlike current generative AI-based tools that generate discrete UML diagrams in an image format, illustrative embodiments generate an XMI representation of UML Models, which include UML diagrams, model elements, and relationships between model elements, based on project-specific architecture solution needs for an architecture solution received from a user via at least one of text and voice inputs. Moreover, illustrative embodiments can modify or enhance diagrams, model elements, and model element relationships in UML Models automatically, with traceability via a version control tool, according to evolving architecture solution project needs.

Thus, illustrative embodiments provide one or more technical solutions that overcome a technical problem with current generative AI-based tools generating UML diagrams in an image format that do not contain model elements or model element metadata. In addition, UML diagrams generated in an image format cannot be modified. In contrast, illustrative embodiments generate XMI representations of UML models that contain diagrams, model elements, and model element relationships and can be modified. As a result, illustrative embodiments provide one or more technical solutions having a technical effect and practical application in the field of architectures.

With reference now to FIG. 2, a diagram illustrating an example of an architecture solution generation system is depicted in accordance with an illustrative embodiment. Architecture solution generation system 201 may be implemented in a computing environment, such as computing environment 100 in FIG. 1. Architecture solution generation system 201 is a system of hardware and software components for generating accurate architecture solutions.

In this example, architecture solution generation system 201 includes computer 202 and client device 204. Computer 202 and client device 204 can be, for example, computer 101 and EUD 103 in FIG. 1. However, it should be noted that architecture solution generation system 201 is intended as an example only and not as a limitation on illustrative embodiments. For example, architecture solution generation system 201 can include any number of computers, client devices, and other devices and components not shown.

In this example, computer 202 includes architecture modeling assistant 206, generative AI-based XMI generator 208, architecture model automation component 210, and architecture modeling tool 212. Architecture modeling assistant 206, generative AI-based XMI generator 208, architecture model automation component 210, and architecture modeling tool 212 can be implemented by architecture solution generation code 200 in FIG. 1.

Architecture modeling assistant 206 selects a foundation model that was pre-trained to process user-specified architecture solution needs, such as project-specific architecture solution needs 214, received in at least one of a text format or a voice format. In addition, architecture modeling assistant 206 selects a foundation model that can be fine-tuned to generate a set of instructions (e.g., prompts) in a predefined format usable by generative AI-based XMI generator 208 and architecture model automation component 210 of illustrative embodiments. Further, architecture modeling assistant 206 selects a foundation model that supports a plurality of languages to ensure larger coverage of the architecture solution across a plurality of different geographic locations.

Generative AI-based XMI generator 208 selects a foundation model that can generate XMI representations of UML models based on sets of instructions in the predefined format generated by architecture modeling assistant 206. When such a foundation model is not available for generative AI-based XMI generator 208 to select, computer 202 generates a new foundation model using a large training dataset that includes sample instructions in the predefined format and corresponding sample XMI representations of existing UML models obtained from a set of authenticated sources, such as, for example, asset repository 130 in FIG. 1, of an entity, such as, for example, an organization, which is known and trusted by computer 202. This new foundation model is capable of self-supervised learning of the patterns of the sample instructions in the predefined format and the corresponding sample XMI representations of existing UML models in the large training dataset to transform or convert the sets of instructions in the predefined format to corresponding XMI representations of UML models. It should be noted that traditional artificial intelligence utilizes supervised learning and unsupervised learning to train the machine learning models. In contrast, generative artificial intelligence utilizes self-supervised learning to train the foundation models. Self-supervised learning is a deep learning technique in generative artificial intelligence used to pre-train foundation models without needing labeled datasets. In addition, it should be noted that architecture modeling assistant 206 and generative AI-based XMI generator 208 can utilize the same foundation model that provides the functionalities or capabilities needed by both architecture modeling assistant 206 and generative AI-based XMI generator 208.

Architecture modeling assistant 206 is a generative AI-based digital assistant. Architect 216 (e.g., a user) utilizes client device 204 to input project-specific architecture solution needs 214 into architecture modeling assistant 206 via text and/or voice inputs. It should be noted that architecture modeling assistant 206 is separate from generative AI-based XMI generator 208, enabling architect 216 to input project-specific architecture solution needs 214 when communicating with architecture modeling assistant 206 rather than having to be an instruction or prompt engineer in order to utilize the functionalities of generative AI-based XMI generator 208 to generate UML models for architecture solutions.

Architecture modeling assistant 206 utilizes the natural language processing (NLP) capabilities of the selected foundation model to process project-specific architecture solution needs 214 input by architect 216 into architecture modeling assistant 206. Computer 202 utilizes generative AI studio software to fine-tune the selected foundation model to generate the set of instructions in the predefined format, which is equivalent to project-specific architecture solution needs 214, using sample needs of existing architecture solutions and corresponding sample equivalent instructions in the predefined format obtained from the set of authenticated sources. Also, many different types of architects, such as, for example, application architects, information architects, infrastructure architects, business architects, and the like, can utilize architecture modeling assistant 206 across all architecture domains corresponding to an entity, such as, for example, an enterprise, company, business, organization, institution, agency, or the like, to generate architecture solutions as UML models.

Computer 202 utilizes the generative AI studio software to fine-tune the foundation model, which is capable of generating XMI representations of UML models, using sample instructions in the predefined format and corresponding sample equivalent XMI representations of existing UML models retrieved from the set of authenticated sources. Computer 202 generates an LLM for generative AI-based XMI generator 208 using the fine-tuned foundation model.

Fine-tuning the foundation model enables the LLM to generate the XMI representations of UML models, along with UML diagrams, UML model elements, and UML model element relationships, needed for architecture solutions based on the sets of instructions in the predefined format generated by architecture modeling assistant 206. Fine-tuning the foundation model also enables the LLM to modify the XMI representations of existing UML models that were generated either manually or through automation. Further, it should be noted that instead of XMI, computer 202 can utilize other formats, such as, for example, mxGraph XML, to represent UML models.

Architecture model automation component 210 is a robotic process automation-based component. Architecture model automation component 210 utilizes robotic process automation (RPA) bots to automatically import generated XMI representations of UML models into architecture modeling tool 212 from generative AI-based XMI generator 208. After successfully importing an XMI representation of a UML model into architecture modeling tool 212, architecture model automation component 210 performs a plurality of various automated tasks, which typically are one-time tasks. The automated tasks include, for example, verifying compatibility of the generated XMI representation of the UML with architecture modeling tool 212, performing validation of the generated UML model using standard UML model validation rules and architecture solution-specific UML model validation rules, ranking the generated UML model using predefined architecture principles and standards for the architecture solution, generating XMI representation compatibility reports, generating UML model validation reports, generating UML model rank reports, and aligning UML model elements in the generated UML diagrams for architecture modeling tool 212. Moreover, architecture model automation component 210 sends the output of certain automated tasks, such as UML model validation, to the corresponding foundation model as feedback to fine-tune the generation of XMI representations of UML models on its own to increase accuracy.

It should be noted that alternative illustrative embodiments can integrate generative AI-based XMI generator 208 with architecture modeling assistant 206 to enable a seamless flow of generating UML models, which include UML diagrams, UML model elements, and UML model element relationships, based on text and voice descriptions of project-specific architecture solution needs 214. Alternative illustrative embodiments can also integrate architecture model automation component 210 with architecture modeling assistant 206 for seamless automation of the various tasks performed on XMI representations of UML models imported into architecture modeling tool 212.

To initiate the architecture solution generation process of computer 202, architect 216 accesses architecture modeling assistant 206 using valid credentials for authentication and authorization. Upon successful authentication and authorization, architect 216 initiates communication with architecture modeling assistant 206 to input project-specific architecture solution needs 214 via at least one of a text format and a voice format. In addition, architect 216 defines a container (i.e., a UML model) for the architecture solution project. If architect 216 does not define the container for the architecture solution project, architecture modeling assistant 206 automatically adds a default container for the architecture solution project.

Project-specific architecture solution needs 214 include, for example, a system context diagram, an architecture overview diagram, a component diagram, a deployment diagram, and the like. Architect 216 defines the system context diagram by communicating the new architecture solution as black box, with various external systems in the eco system and details of the various external systems integrations. Also, architect 216 defines the architecture overview diagram by communicating various layers, components in each of the various layers, relationships between the components in each layer, and the like. In addition, architect 216 defines the component model by communicating various layers, components in each of the various layers, relationships between the components in each layer, and the like. Further, architect 216 defines the deployment diagram by communicating various geographic locations, network zones, components in each intersection of a geographic location and a network zone, interactions between the components in an intersection of a geographic location and a network zone, and the like.

Architecture modeling assistant 206 uses the NLP capability of the selected foundation model to process and analyze project-specific architecture solution needs 214 and uses the code generating LLM of the selected foundation model to translate or convert project-specific architecture solution needs 214 into a set of equivalent instructions (e.g., prompts) in predefined formats suitable for utilization by generative AI-based XMI generator 208 and architecture model automation component 210 based on the analysis of project-specific architecture solution needs 214. The set of equivalent instructions in the predefined formats can be, for example, a prompt to generate a system context diagram for an online retail store in a retail solution model within an ecosystem that contains a logistics system, a warehouse management system, a weather forecasting system, and the like, where each different system utilizes a different predefined format.

Afterward, architecture modeling assistant 206 sends set of instructions in predefined format 218, which is equivalent to project-specific architecture solution needs 214, to generative AI-based XMI generator 208. At 220, in response to receiving set of instructions in predefined format 218, generative AI-based XMI generator 208 uses the code generating LLM of the selected foundation model to generate XMI representation of UML model 222 using set of instructions in predefined format 218, which is equivalent to project-specific architecture solution needs 214. In addition, architecture modeling assistant 206 communicates a result of generating XMI representation of UML model 222 (e.g., whether generating XMI representation of UML model 222 was a success or a failure) to architect 216 via client device 204.

It should be noted that architect 216 can also include at least one of a set of functional requirements and a set of non-functional requirements in project-specific architecture solution needs 214. Computer 202 can utilize entity extraction, classification, and other traditional AI or generative AI techniques to identify various model elements needed in an architecture model of an architecture solution, such as architecture solution 236, from project-specific architecture solution needs 214. In addition, the interaction between architect 216 and architecture modeling assistant 206 can occur at the individual model construct level (e.g., system context diagram) or the overall UML model level.

In response to generative AI-based XMI generator 208 generating XMI representation of UML model 222 using set of instructions in predefined format 218, which is equivalent to project-specific architecture solution needs 214, architecture modeling assistant 206, at 224, uses architecture model automation component 210 to perform set of automated tasks 226. For example, at 228, architecture model automation component 210 automatically opens architecture modeling tool 212. In addition, at 230, architecture model automation component 210 automatically imports XMI representation of UML model 222 into architecture modeling tool 212 from generative AI-based XMI generator 208. Further, architecture model automation component 210 automatically verifies compatibility of XMI representation of UML model 222 with architecture modeling tool 212.

Afterward, in response to receiving XMI representation of UML model 222, architecture modeling tool 212, at 232, generates UML model 234 based on XMI representation of UML model 222. Furthermore, architecture model automation component 210 automatically validates UML model 234 using standard UML model validation rules and UML model validation rules specific for architecture solution 236. Moreover, architecture model automation component 210 automatically ranks UML model 234 based on a set of principles and standards defined for architecture solution 236. In addition, architecture model automation component 210 performs an automated alignment of UML model elements in UML diagrams of UML model 234 for architecture modeling tool 212. Architecture model automation component 210 also automatically generates an XMI representation compatibility report, a UML model validation report, and a UML model rank report for architect 216. Architecture model automation component 210 sends the XMI representation compatibility report, the UML model validation report, and the UML model rank report to architect 216 via client device 204.

In response to receiving positive feedback from architect 216 regarding the XMI representation of UML Model 234 through XMI representation compatibility report, the UML model validation report, and the UML model rank report, architecture model automation component 210 incorporates UML model 234 into architecture solution 236. In addition, in response to receiving an input to implement architecture solution 236, architecture model automation component 210 implements architecture solution 236 in an environment corresponding to architect 216. Furthermore, architecture model automation component 210 feeds the XMI representation compatibility report, the UML model validation report, and the UML model rank report into the corresponding foundation model for retraining and fine-tuning via self-learning to increase the accuracy of generating XMI representations of UML models on its own. It should be noted that computer 202 can use predefined mapping, naming conventions, or other similar approaches to automatically apply specific UML model stereotypes to UML model elements via architecture model automation component 210.

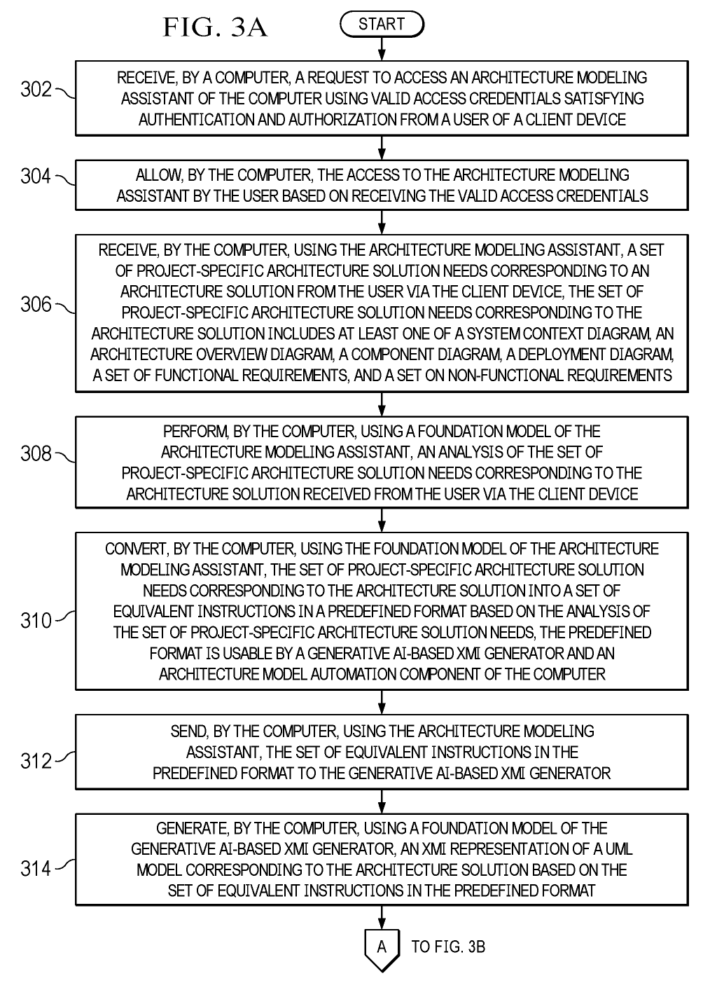

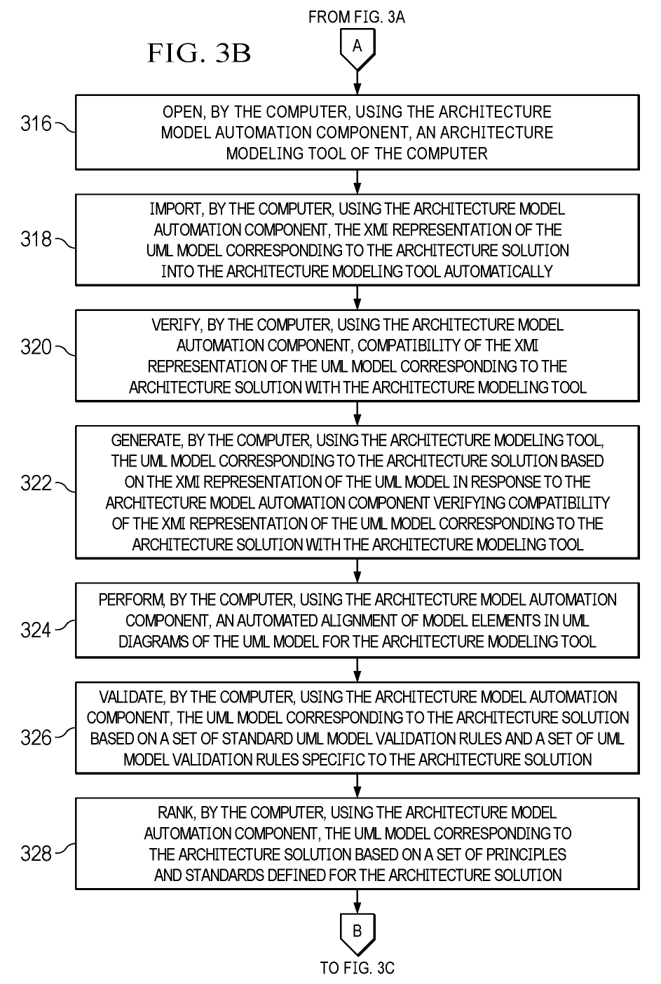

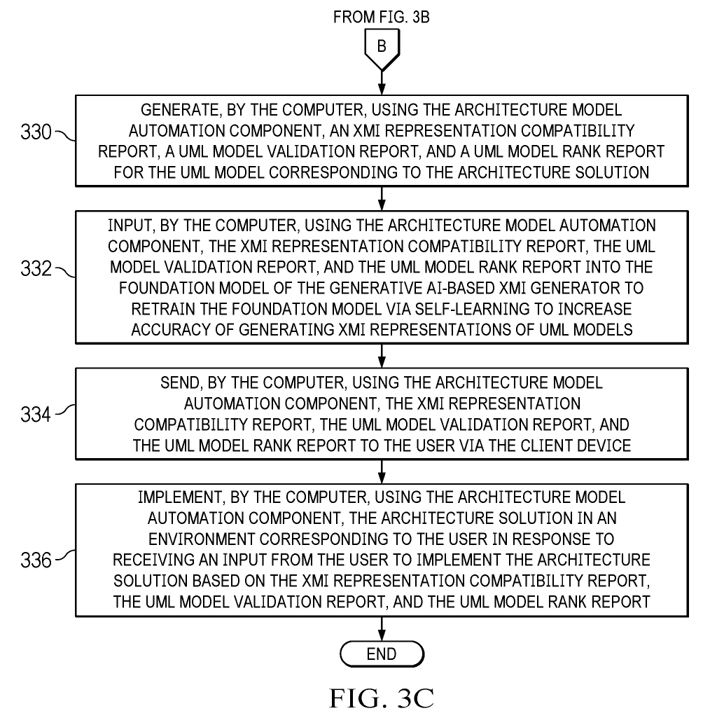

With reference now to FIGS. 3A-3C, a flowchart illustrating a process for generating architecture solutions is shown in accordance with an illustrative embodiment. The process shown in FIGS. 3A-3C may be implemented in a computer, such as, for example, computer 101 in FIG. 1 or computer 202 in FIG. 2. For example, the process shown in FIGS. 3A-3C may be implemented by architecture solution generation code 200 in FIG. 1.

The process begins when the computer receives a request to access an architecture modeling assistant of the computer using valid access credentials satisfying authentication and authorization from a user of a client device (step 302). The computer allows the access to the architecture modeling assistant by the user based on receiving the valid access credentials (step 304).

The computer, using the architecture modeling assistant, receives a set of project-specific architecture solution needs corresponding to an architecture solution from the user via the client device in response to allowing access by the user (step 306). The set of project-specific architecture solution needs corresponding to the architecture solution includes at least one of a system context diagram, an architecture overview diagram, a component diagram, a deployment diagram, a set of functional requirements, and a set on non-functional requirements. At high level, the set of project-specific architecture solution needs refers to generating an architecture solution for the project. In other words, the actual description of the architecture solution is provided according to the project needs or requirements.

The computer, using a foundation model of the architecture modeling assistant, performs an analysis of the set of project-specific architecture solution needs corresponding to the architecture solution received from the user via the client device (step 308). The computer, using the foundation model of the architecture modeling assistant, converts the set of project-specific architecture solution needs corresponding to the architecture solution into a set of equivalent instructions in a predefined format based on the analysis of the set of project-specific architecture solution needs (step 310). The predefined format is usable by a generative AI-based XMI generator and an architecture model automation component of the computer.

The computer, using the architecture modeling assistant, sends the set of equivalent instructions in the predefined format to the generative AI-based XMI generator (step 312). The computer, using a foundation model of the generative AI-based XMI generator, generates an XMI representation of a UML model corresponding to the architecture solution based on the set of equivalent instructions in the predefined format (step 314).

The computer, using the architecture model automation component, opens an architecture modeling tool of the computer (step 316). In addition, the computer, using the architecture model automation component, imports the XMI representation of the UML model corresponding to the architecture solution into the architecture modeling tool automatically (step 318).

The computer, using the architecture model automation component, verifies compatibility of the XMI representation of the UML model corresponding to the architecture solution with the architecture modeling tool (step 320). The computer, using the architecture modeling tool, generates the UML model corresponding to the architecture solution based on the XMI representation of the UML model in response to the architecture model automation component verifying compatibility of the XMI representation of the UML model corresponding to the architecture solution with the architecture modeling tool (step 322).

The computer, using the architecture model automation component, performs an automated alignment of model elements in UML diagrams of the UML model for the architecture modeling tool (step 324). The architecture model automation component performs the automated alignment of the model elements in the UML diagrams of the UML model to improve readability of the UML diagrams. The computer, using the architecture model automation component, validates the UML model corresponding to the architecture solution based on a set of standard UML model validation rules and a set of UML model validation rules specific to the architecture solution (step 326).

The computer, using the architecture model automation component, ranks the UML model corresponding to the architecture solution based on a set of principles and standards defined for the architecture solution (step 328). The computer, using the architecture model automation component, generates an XMI representation compatibility report, a UML model validation report, and a UML model rank report for the UML model corresponding to the architecture solution (step 330).

The computer, using the architecture model automation component, inputs the XMI representation compatibility report, the UML model validation report, and the UML model rank report into the foundation model of the generative ai-based XMI generator to retrain the foundation model via self-learning to increase accuracy of generating XMI representations of UML models (step 332). Further, the computer, using the architecture model automation component, sends the XMI representation compatibility report, the UML model validation report, and the UML model rank report to the user via the client device (step 334). Furthermore, the computer, using the architecture model automation component, implements the architecture solution in an environment corresponding to the user in response to receiving an input from the user to implement the architecture solution based on the XMI representation compatibility report, the UML model validation report, and the UML model rank report (step 336). Thereafter, the process terminates.

Thus, illustrative embodiments of the present disclosure provide a computer-implemented method, computer system, and computer program product for generating accurate architecture solutions in an accelerated manner using robotic process automation and self-learning generative AI. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating architecture solutions, the computer-implemented method comprising:
generating, by a computer, an Extensible Markup Language Metadata Interchange (XMI) representation of a Unified Modeling Language (UML) model corresponding to an architecture solution based on a set of instructions in a predefined format; and
generating, by the computer, the UML model corresponding to the architecture solution based on the XMI representation of the UML model.

2. The computer-implemented method of claim 1, further comprising:
performing, by the computer, an automated alignment of model elements in UML diagrams of the UML model.

3. The computer-implemented method of claim 1, further comprising:
validating, by the computer, the UML model corresponding to the architecture solution based on a set of standard UML model validation rules and a set of UML model validation rules specific to the architecture solution; and
ranking, by the computer, the UML model corresponding to the architecture solution based on a set of principles and standards defined for the architecture solution.

4. The computer-implemented method of claim 1, further comprising:
generating, by the computer, an XMI representation compatibility report, a UML model validation report, and a UML model rank report for the UML model corresponding to the architecture solution; and
inputting, by the computer, the XMI representation compatibility report, the UML model validation report, and the UML model rank report into a foundation model to retrain the foundation model via self-learning to increase accuracy of generating XMI representations of UML models.

5. The computer-implemented method of claim 4, further comprising:
sending, by the computer, the XMI representation compatibility report, the UML model validation report, and the UML model rank report to a user via a client device; and
implementing, by the computer, the architecture solution in an environment corresponding to the user in response to receiving an input from the user to implement the architecture solution based on the XMI representation compatibility report, the UML model validation report, and the UML model rank report.

6. The computer-implemented method of claim 1, further comprising:
importing, by the computer, the XMI representation of the UML model corresponding to the architecture solution into an architecture modeling tool; and
verifying, by the computer, compatibility of the XMI representation of the UML model corresponding to the architecture solution with the architecture modeling tool.

7. The computer-implemented method of claim 1, further comprising:
receiving, by the computer, a set of project-specific architecture solution needs corresponding to the architecture solution from a user via a client device;
performing, by the computer, an analysis of the set of project-specific architecture solution needs corresponding to the architecture solution received from the user via the client device; and
converting, by the computer, using a foundation model, the set of project-specific architecture solution needs corresponding to the architecture solution into the set of instructions in the predefined format based on the analysis of the set of project-specific architecture solution needs.

8. The computer-implemented method of claim 7, wherein the set of project-specific architecture solution needs corresponding to the architecture solution includes at least one of a system context diagram, an architecture overview diagram, a component diagram, a deployment diagram, a set of functional requirements, and a set on non-functional requirements, and wherein the predefined format is usable by a generative artificial intelligence-based XMI generator and an architecture model automation component of the computer.

9. A computer system for generating architecture solutions, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
generate an Extensible Markup Language Metadata Interchange (XMI) representation of a Unified Modeling Language (UML) model corresponding to an architecture solution based on a set of instructions in a predefined format; and
generate the UML model corresponding to the architecture solution based on the XMI representation of the UML model.

10. The computer system of claim 9, wherein the set of processors further executes the program instructions to:
perform an automated alignment of model elements in UML diagrams of the UML model.

11. The computer system of claim 9, wherein the set of processors further executes the program instructions to:
validate the UML model corresponding to the architecture solution based on a set of standard UML model validation rules and a set of UML model validation rules specific to the architecture solution; and
rank the UML model corresponding to the architecture solution based on a set of principles and standards defined for the architecture solution.

12. The computer system of claim 9, wherein the set of processors further executes the program instructions to:
generate an XMI representation compatibility report, a UML model validation report, and a UML model rank report for the UML model corresponding to the architecture solution; and
input the XMI representation compatibility report, the UML model validation report, and the UML model rank report into a foundation model to retrain the foundation model via self-learning to increase accuracy of generating XMI representations of UML models.

13. The computer system of claim 12, wherein the set of processors further executes the program instructions to:
send the XMI representation compatibility report, the UML model validation report, and the UML model rank report to a user via a client device; and
implement the architecture solution in an environment corresponding to the user in response to receiving an input from the user to implement the architecture solution based on the XMI representation compatibility report, the UML model validation report, and the UML model rank report.

14. A computer program product for generating architecture solutions, the computer program product comprising a set of computer-readable storage media having program instructions collectively stored therein, the program instructions executable by a computer to cause the computer to:
generate an Extensible Markup Language Metadata Interchange (XMI) representation of a Unified Modeling Language (UML) model corresponding to an architecture solution based on a set of instructions in a predefined format; and
generate the UML model corresponding to the architecture solution based on the XMI representation of the UML model.

15. The computer program product of claim 14, wherein the program instructions further cause the computer to:
perform an automated alignment of model elements in UML diagrams of the UML model.

16. The computer program product of claim 14, wherein the program instructions further cause the computer to:
validate the UML model corresponding to the architecture solution based on a set of standard UML model validation rules and a set of UML model validation rules specific to the architecture solution; and
rank the UML model corresponding to the architecture solution based on a set of principles and standards defined for the architecture solution.

17. The computer program product of claim 14, wherein the program instructions further cause the computer to:
generate an XMI representation compatibility report, a UML model validation report, and a UML model rank report for the UML model corresponding to the architecture solution; and
input the XMI representation compatibility report, the UML model validation report, and the UML model rank report into a foundation model to retrain the foundation model via self-learning to increase accuracy of generating XMI representations of UML models.

18. The computer program product of claim 17, wherein the program instructions further cause the computer to:
send the XMI representation compatibility report, the UML model validation report, and the UML model rank report to a user via a client device; and
implement the architecture solution in an environment corresponding to the user in response to receiving an input from the user to implement the architecture solution based on the XMI representation compatibility report, the UML model validation report, and the UML model rank report.

19. The computer program product of claim 14, wherein the program instructions further cause the computer to:
import the XMI representation of the UML model corresponding to the architecture solution into an architecture modeling tool; and
verify compatibility of the XMI representation of the UML model corresponding to the architecture solution with the architecture modeling tool.

20. The computer program product of claim 14, wherein the program instructions further cause the computer to:
receive a set of project-specific architecture solution needs corresponding to the architecture solution from a user via a client device;
perform an analysis of the set of project-specific architecture solution needs corresponding to the architecture solution received from the user via the client device; and
convert, using a foundation model, the set of project-specific architecture solution needs corresponding to the architecture solution into the set of instructions in the predefined format based on the analysis of the set of project-specific architecture solution needs.
